(19) United States
(12) Patent Application Publication
(10) Pub. No.: US 2009/0325138 A1
(43) Pub. Date: Dec. 31, 2009

(54) VIRTUAL INTERACTIVE CLASSROOM USING GROUPS

(76) Inventor: Gary Stephen Shuster, Fresno, CA (US)

Correspondence Address: CONNOLLY BOVE LODGE & HUTZ LLP, P.O. BOX 2207, WILMINGTON, DE, 19899, US

(21) Appl. No.: 12/492,947

(22) Filed: Jun. 26, 2009

Related U.S. Application Data
(60) Provisional application No. 61/075,816, filed on Jun. 26, 2008.

(51) Int. Cl. G09B 5/00

(52) U.S. Cl. 434/350

(57) ABSTRACT

An online environment server hosts an event, such as a class period or interactive entertainment event, in a virtual reality process. Clients are divided into groups as they join the process according to defined group and user profiles and current group capacities. A human host, such as a teaching assistant, may also join each group as a moderator or administrator. Each group member interacts in real time with other group members via electronic chat. Recordings of group sessions may be accessed later by non-group members. The group server is configured such that the group moderator or administrator may control classroom data flow for her assigned group, such as pausing an animated stream of instructor or event input into the virtual classroom to allow classroom questions or discussion, causing the stream to be cached at the system level. Then, the moderator may resume play of the instructional sequence. When resuming play after a pause, the system server may automatically speed up play of the animated input stream from a cache while continuing to cache as necessary, until parity is reached with the current input stream for all groups.

### CROSS-REFERENCE TO RELATED APPLICATION

This application claims priority pursuant to 35 U.S.C. § 119(e) to U.S. provisional application Ser. No. 61/075,816, filed Jun. 26, 2008, which is hereby incorporated by reference, in its entirety.

### BACKGROUND

1. Field

The present disclosure relates to technical systems and methods facilitating virtual interactive classrooms.

2. Description of Related Art

Online learning is a useful and fairly well-established educational tool that is implemented in a wide variety of different ways. Opportunities may exist to improve upon existing online methods and systems for providing online education. For example, classroom environments may be made more responsive to individual students or small groups, while leveraging the expertise and teaching skills of the most skilled instructors across large participant groups. It would be desirable to provide these capabilities in an engaging and cost-effective fashion.

### SUMMARY

U.S. Provisional Application 60/893,531, filed Mar. 7, 2007, and PCT Application PCT 08/56150, filed Mar. 7, 2008, now published at WO/2008/109798, which are incorporated herein by reference, disclose dynamically establishing and managing multiple instances of a space within a Virtual Reality Universe (“VRU”) modeled in an online, multiuser computing environment. Such multiple instances are referred to therein as “dimensions.” Those applications disclose the creation of an unlimited number of duplicate instances of a space in a VRU, which instances are created dynamically, and which instances users can interact across. Furthermore, the application disclose that such dimensions may be utilized in a manner that does little or nothing to impair the ability of the VRU to emulate those portions of the real world environment that may be crucial to a positive user experience within a VRU. These features may be applied to enhance on-line interactive educational and entertainment venues with live teachers or performers.

For example, a classroom server may create multiple groups participating in the same lecture or event, as new dimension or areas. Each new area may then be populated with clients seeking participate in the class or other live event, optionally grouped by user profile or other criteria. If a new group reaches its occupancy capacity, the server may generate additional new groups as needed to handle demand. Each group comprises a distinct multi-user server session with defined participants. Selected participants, for example a professor, may participate simultaneously in more than one group.

In other embodiments disclosed in the above-mentioned applications, other algorithms for populating participant groups may be used. Such algorithms may include, for example, adding new users to the least populated group. Thus, if one or more users have left a first group, new users might be preferentially placed in the first group before a second group reaches its occupancy capacity. For further example, users may be added approximately evenly across several groups all of which are below their occupancy capacity, and/or users may be placed in one of plural groups based on the users' status, achievements or other classifications. Users may also create their own groups with limited enrollment or purposes. These may include and/or permit, without limitation, (a) themselves; (b) a private party; (c) members of a group; (d) the public at large; (e) paid attendees; and/or (f) specified invitees.

In other embodiments, the server may populate participant groups based on user generated preferences. Thus, for example, a Spanish speaking user may prefer to populate a classroom shared by other Spanish speaking users. Similarly, users from language groups that are more easily translated in a mechanical manner into the other users' languages may be treated as a single group. Thus, for example, if Spanish and French are more easily translated between than are Spanish and Chinese, the Spanish and French users may be grouped together in a classroom equipped with a translation function.

The prior applications also disclose that a defined area or portion of multiple related dimensions or groups may be visible to, and/or interact with, other parts or members of the groups. For example, a stage area or teaching lectern may be defined that is visible and audible in multiple classrooms surrounding the stage area or lectern. Access to such a stage or common area may be limited in any desired way. Actions on the stage may affect multiple dimensions. For example, if a teaching avatar operated by the professor for multiple classrooms writes an equation on a virtual wall board, that wallboard and written equations may be transmitted to and visible to all groups in near simultaneous time. Conversely, the surrounding multi-dimensional areas or classrooms may influence a common area. Continuing the classroom example, a teacher on a common lectern may receive student questions from multiple surrounding classrooms. The avatar operated by the professor exemplifies a digital object—e.g., an avatar—that has a multi-instance presence in more than one dimension. In an embodiment of the invention, the presence in multiple dimensions may be asynchronous. In other words, each instance of the object in multiple dimensions may be generated asynchronously, depending on input from each dimension. In the alternative, the object may be generated synchronously, meaning as a single instance using the same input for each dimension.

In the present application, the tools and concepts of the above-referenced applications are adapted for use in on-line, live interactive multi-participant educational and entertainment applications. For example, a network server may host an event such as a lecture, educational film, or the like to multiple remote clients, which users may want to comment on in real time. The server may divide the viewers into various dimensions based upon criteria related to the expected content, requirements, or other characteristics of the likely conversation or lecture. The server may operate to permit users to electronically chat within their own dimension while hearing, viewing or otherwise perceiving the lecture or other event. Optionally, these dimensions would have a chat leader.

For further example, a network server may operate an application for serving online school offering lectures led by a professor and assisted by five teaching assistants. The professor is giving the lecture and the class may be split using the techniques referenced above into 5 groups, each in their own virtualized dimension, to watch the lecture. Each dimension may have an associated teaching assistant. The professor, assistants, and students may all be simultaneously connected to the host server via individual network connections to respective client terminals. As the lecture is given, the students may engage in text (or other) chat amongst themselves in a manner that enhances the learning experience, using input/output devices of the client terminals that are transmitted to the host, aggregated, and distributed back to appropriate ones of the virtual classrooms.

The server may operate to enable the teaching assistant to moderate or participate in the chat. Optionally, students may listen in on other chat sessions in other dimensions, or replay them in the future, by accessing recorded sessions stored on the server or locally at the client. In addition, the teaching assistant may be given the ability to pause the lecture for one out of several virtual classrooms only, thereby causing the live lecture in that classroom to lag behind real time for a limited period, while students hash out some point in the lecture. Optionally, to get the lecture back to real time, when the teaching assistant unpauses the lecture, the host server may then time-compress the lecture feed to allow the lecture to catch up to real time, again permitting the students to interact with the professor in real time. For example, the server may increase the frame rate or edit out silent parts of the feed on the fly, to increase the relative playback rate until parity with the other virtual classrooms is reached.

A more complete understanding of systems and methods for generating, maintaining and using a virtual interactive classroom using groups will be afforded to those skilled in the art, as well as a realization of additional advantages and objects thereof, by a consideration of the following detailed description. Reference will be made to the appended sheets of drawings which will first be described briefly.

### BRIEF DESCRIPTION OF THE DRAWINGS

FIG. 1 is a system diagram showing an example of a networked computer system for generating, maintaining and using a virtual interactive classroom using groups.

FIG. 2 is a block diagram showing elements of a system for generating, maintaining and using a virtual interactive classroom using groups.

FIG. 3 is a block diagram showing additional aspects of a system for generating, maintaining and using a virtual interactive classroom using groups.

FIG. 4 is a block diagram showing elements of a virtual reality (VR) engine adapted for generating a virtual interactive classroom.

FIG. 5 is a flow diagram showing elements of a method for generating and maintaining a virtual interactive classroom using groups.

### DETAILED DESCRIPTION

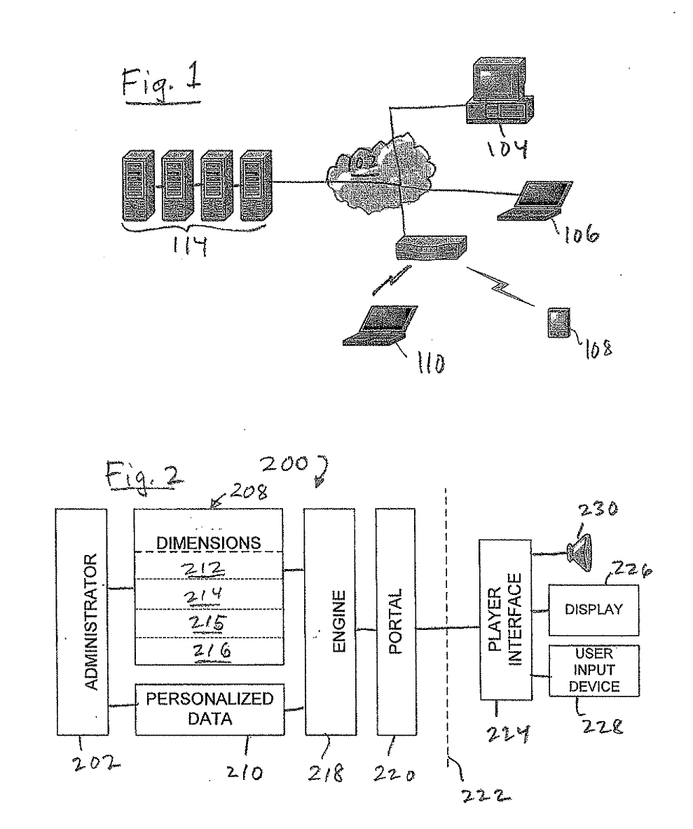

Referring to FIG. 1, a system 100 for providing a multiple multi-user sessions to multiple users may comprise a plurality of client sites, nodes or terminals, for example a personal computer 104, portable computers 106, 110, a compact player, cell phone or digital assistant 108, and/or router 112 communicating via a WAN 102 to one or more servers 114. Servers 114 store and serve process data and software to the client sites. Software or firmware may also be located at each client site, configured to work cooperatively with software or firmware operating on servers 114. Generally, any number of users may be communicating with servers 114 for participation in the multi-user remote computing process at any given time. Software, firmware, or both, may be installed at the servers 114 for controlling a multi-user process as described herein. Client level software may be designed to work cooperatively with sever-level applications to receive user inputs and output a display of a virtual-reality classroom that is managed at the server level. Servers 114 receive input from multiple clients, process the input to define current states of parallel virtual-reality classrooms, and output current state data to the clients. Further details are provided in the detailed description below.

Referring to FIG. 2, a system 200 for providing a multi-user group-segregated process may be considered to be comprised of server-side components (to the left of dashed line 222) and client-side components (to the right of dashed line 222). Server-side components may comprise a portal 220 for managing connections to multiple simultaneous players. Portal 220 may interact with a multi-user process engine 218, passing user input from multiple clients to a multi-user process engine, and passing data from the multi-user process engine to respective individual clients. Multi-user process engine 218 may be operatively associated with various memory spaces, including dimensional spaces 208 holding two or more parallel dimensions 212, 214, 215 and 216, and a personalized or common data space 210. As known in the art, objects in a multi-user process are modeled as three-dimensional objects, or two-dimensional objects, having a defined location, orientation, surface, surface texture, and other properties for graphic rendering or game behavior. Dimensional memory space 208 may hold active or inactive instances of defined spaces used in the multi-user process environment. For example, the environment of a classroom or theater may be replicated in different spaces. Personalized space 210 may be comprised of various different personal areas each assigned to a different user, for example, avatar or avatar accessories data. The multi-user process engine may operate with other memory areas not shown in FIG. 2, for example various data libraries, archives, and records not inconsistent with the methods and systems disclosed herein.

A separate administration module 202 may operate at the server level to create, update, modify or otherwise control the content of the multi-user process as defined in the memory areas 204 and 210. Generally, changes in the personal space area 210 are driven by individual users, either through the multi-user process administrator 202 or another module. Control of common areas, i.e., the game environment and the objects in it, including any multi-dimensional areas, may be via the administrator module 202.

At the client level, a user interface module 224 may be installed to receive user inputs from one or more user input devices 228, such as a keyboard, mouse or other pointer, or microphone, and provide data to the multi-user process engine 218 via portal 222 in response to the input. The player interface module may also receive multi-user process data from portal 220 and process the data for display on display 226 and/or for audio output on speaker 230. Various systems and methods for providing a multi-user process to multiple clients are known in the art, or may be adapted by one of ordinary skill for use with the invention. For example, rendering of a scene may be performed at the client or server level. Generally, it may be advantageous to perform calculations and graphics operations, to the extent possible, at the client level, thereby freeing up network bandwidth and minimizing loads on the server. The invention is not limited to a particular hardware or software architecture for carrying out the steps described herein.

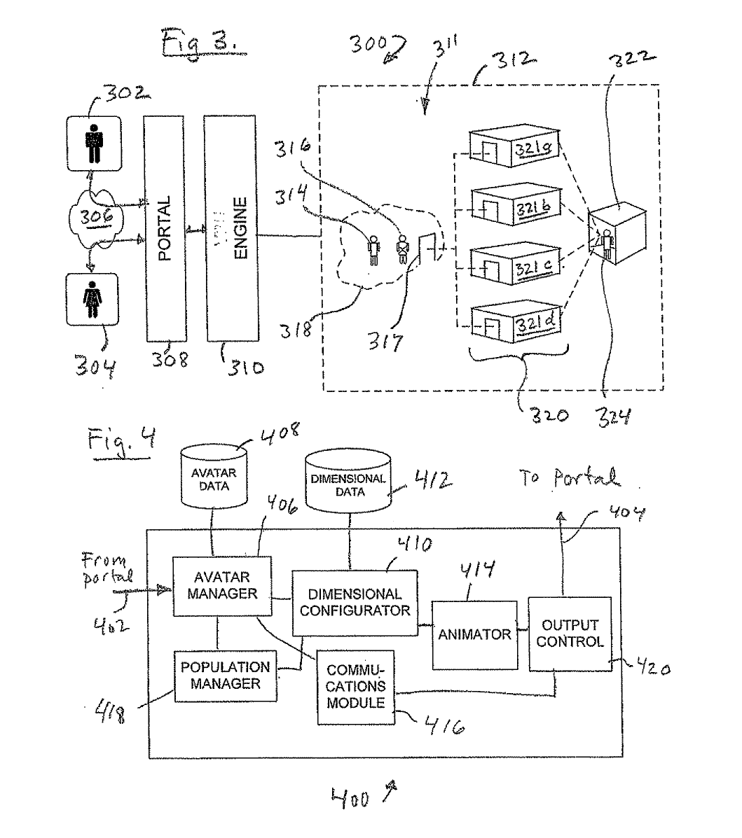

FIG. 3 shows in schematic fashion a system 300 for providing a multi-user, multi-dimensional animated classroom. System 300 comprises a portal or interface 308 connected to receive data, such as through a wide area network 306, from a plurality of users 302, 304 (two of many shown). Users 302, 304 may operate a client computer having a web browser or application configured to communicate commands and data to multi-user process engine 310 via interface 308. Multi-user process engine 310 may model a virtual three-dimensional or other user interface environment 311 within a computer memory 312. A first user 302 may provide commands via portal 308 to multi-user process engine 310 used to control the operation of a first avatar 314. Likewise, a second user 304 may control a second avatar 316. Use of modeled avatars representing spectators or students is optional. The multi-user process engine 310 may limit modeling of avatars or other representations of teachers, teaching assistants, performers and other group leaders. Different roles within the virtual reality environment may be assigned to different clients. For example, teachers may be assigned a controlling role in classroom oversight, teaching assistants a lesser role, and students assigned a role with learning responsibilities and rights but not classroom control.

Environment 311 may include multiple scenes or regions modeled to simulate a region of space, for example, the inside of a class room or building, the inside of a theater or arena, and so forth. It should be appreciated that FIG. 3 presents a highly simplified schematic view of a modeled environment. An actual modeled environment may be highly complex, including thousands of different modeled spaces, some or all of which may exist in more than one dimension. Modeled scenes or spaces may be of different types, meaning they may be modeled according to different rules. The server may allow interactivity with multiple spaces, at least for some avatars in the environment 311. Instead of three-dimensional modeled spaces, the multi-user process engine 310 may generate the classroom or other group space as a two-dimensional representation of a three-dimensional space.

Multi-user process engine 310 may operate such that some scenes in environment 311 may be capable of being replicated to create another instance of the scene, for example multi-dimensional spaces 320, while other scenes cannot be replicated, for example a non-replicable or mono-dimensional space 318. Thus, environment 311 may contain both types of spaces, as well as portals or transportation elements allowing avatars to transport between multi-dimensional and mono-dimensional spaces. Avatars 314, 316 present in mono-dimensional space 318 may be transported via portal 317 to any one of the multi-dimensional spaces 320. Conversely, avatars in the multi-dimensional spaces 320 may pass into space 318 via portal 317, which may be replicated as an instance in each multi-dimensional space 321a-d.

Multi-dimensional spaces 320 may originate as a single mono-dimensional, bounded modeled space. If the space becomes overly crowded, or if it is desired to segregate participants for other reasons, it may be replicated in any number of instances to accommodate as many participants as desired. However, the replicated space is not merely a copy, but rather exists as a connected part of the same environment 311. For example, space 321d may be a popular classroom originally existing in a single instance. As the popularity of the class grows, it may be desirable, for example, to replicate the available classroom space for new students. Hence, each additional classroom 321b, c and d may be created in response to population threshold of the existing class instances being exceeded. Each additional classroom may allow for two-way travel through a portal 317 to a common area, or through any number of alternative portals.

The additional dimensions 321b-d may therefore provide the advantages of accommodating any number of students without requiring students to subscribe to a new session or environment 311. In addition, students may be segregated into different groups, for example, by language, and still participate in the same live event. The most popular and successful destination in the environment 311 may therefore be enjoyed by more students, almost without limit. Students are therefore not required to exit a particular session or environment to enjoy these popular attractions. Likewise, users need not be cut off from communicating with or otherwise interacting with any other users participating in the multi-user environment 311 while still being able to freely access the most crowded destinations within the environment.

The existence of multiple classrooms 320 may be revealed or hidden from some or all users 302, 304. In an embodiment of the invention, some or all users may enter into one or a series of multi-dimensional spaces without being aware of the existence of other dimensions. In the alternative, users may be given an indication that they are connected to or entering a space for which multiple instances exist. Both alternatives may co-exist within the same environment 311, depending on the identity of the user and desired characteristics of a multi-dimensional space.

Environment 311 may further comprise one or more common spaces 322 that provide for simultaneous interaction with multiple instances of parallel dimensions 320. For example, a common space may comprise a lectern for a classroom. The interior of the common space may be visible and/or audible in each of the dimensions 321a-d. An avatar or other object in the common space 322, for example, a teacher avatar, may be able to pass into each of the parallel spaces, being replicated in the process. In a classrooms live teaching embodiment, the VRU engine may cause a teacher avatar modeled in the common space 322 to respond in real time to inputs from a designated teaching client. Certain objects or avatars may also be able to pass from the parallel dimensions 320 into the common area. For example, avatars may queue up inside of different parallel dimensions and be granted access to the common area 322 in sequence. For further example, some avatars may be granted special rights or powers that permit them to enter a common space 322 that permits simultaneous interaction with multiple dimensions. Various other exemplary interactions between common spaces and parallel dimensions will be described in the detailed description below.

FIG. 3 may also serve to illustrate an alternative embodiment in which users are segregated into independent, isolated groups that simultaneously share a simulated space or facility modeled from same data in the multi-user process engine's memory, at each client. In this embodiment, the dimensions 321a-d may represent isolated groups of avatars and interactive objects. Such groups may be contained within a non-interactive common environment, such as the walls, ceilings and floors of a simulated classroom or other space. The non-interactive common environment may serve as common backdrop that is shared by the different groups 321a-d, which need not be aware of one another's existence. This embodiment serves to illustrate that the experience of multiple parallel dimensions may be implemented in various ways, without departing from the spirit and scope of the inventions.

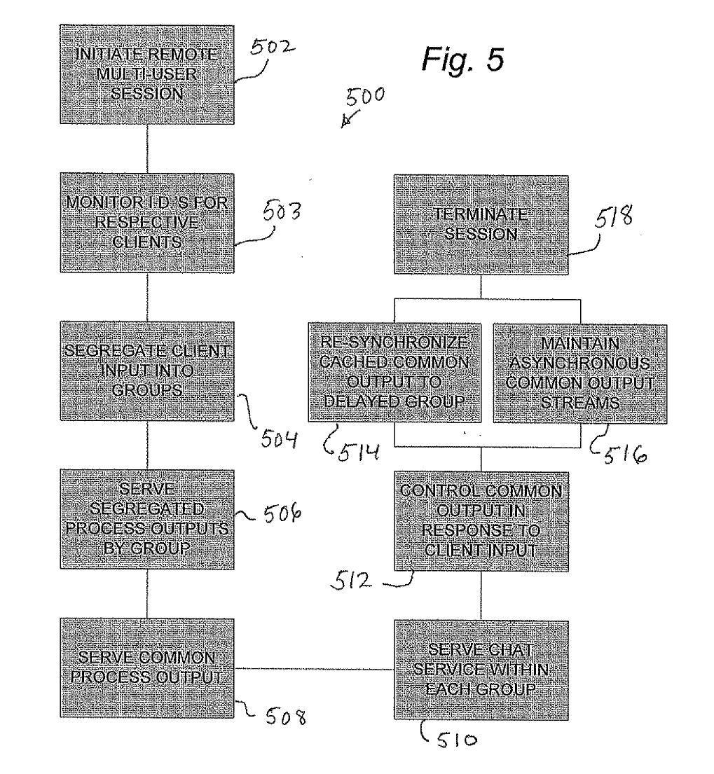

FIG. 4 is a block diagram showing exemplary aspects of a multi-dimensional system 400. System 400 may be implemented, for example, by a server or group of servers operating at a network accessible site. Input data 402, including for example user commands or data used to direct the motion of avatars and other objects, may be provided to system 400 via a portal. Output data 404, including for example virtual-reality data configured to cause remote clients to output an animated display of a corresponding one of the parallel dimensions and avatars therein, may be output to a portal module for distribution to remote clients.

System 400 may comprise an avatar manager component 406 operably connected to a database 408 of avatar data. Like other components of system 400, the avatar manager component 406 may be implemented in any suitable software, hardware, or combination thereof. The avatar manager may process incoming user commands and associate commands with corresponding avatar and other object data. The avatar manager may manage student, teacher, and teaching assistant avatars, providing respective types of input to the classroom environment. The avatar manager may communicate with a dimensional configurator 410 and population manager 418 to ensure that each student avatar is placed correctly in one of parallel groups managed by the configurator and population manager. The avatar manager may further communicate with an animation component 414 to ensure that each avatar is positioned and moved in accordance with user commands, if applicable. In addition, the avatar manager may cooperate with a communications component that operates to allow communication, for example text or audio chat, between different users. In some embodiments, live audio chat may be obtained from one or more designated teachers and broadcast within the environment, while student responses are limited to text chat.

A population manager 418 may monitor the population density of student avatars in defined area of the environment, or more generally throughout the environment. If a population threshold is exceeded, the population manager may instruct the dimensional configurator 410 to generate or activate another instance of the overcrowded area. Likewise, the population manager may monitor parallel dimensions, and instruct the dimensional configurator to collapse two or more parallel dimensions into one, if population density falls below a defined threshold.

A dimensional configurator 410 may generate or activate additional parallel dimensions as needed to accommodate population growth. Essentially, the configurator may generate another instance of a crowded space within a virtual-reality environment by copying an existing space or template. In the alternative, different avatar populations may share common elements defining the envelope of a modeled space. Elements of modeled spaces may be stored in a dimensional database 412 in operative association with the configurator 410. The configurator may also ensure, in cooperation with the avatar manager 406, that each dimension is correctly populated with avatars. The configurator 410 may also operate to collapse empty or sparsely populated ones of parallel dimensions. For example, the configurator may move remaining avatars to another dimension and inactivate or delete the emptied dimension.

A communications module 416 may operate more or less independently of other components to enable communication, such as chat, between different users located in the same group or dimension. In addition, the communications module may permit users to place a chat “telephone call” to any user logged into the system, regardless of the relative locations of the users' avatars. In this way, a user in classroom group ‘A’ may chat with a specific identified user in another group, e.g., classroom ‘B’, if the “telephone number” or other ID for the other user is known.

An animation component 414 may operate to process user commands, dimensional data and other model data to produce simulations of all active parallel spaces and other active regions of the modeled environment. Generally, a space or region may be considered active if it is within sight of a user-selected viewpoint. Various methods are known for simulating avatars and objects within modeled spaces, and any suitable method may be used. In addition, it is anticipated that new methods may be developed that may also be suitable. In general, any method that is suitable for modeling non-parallel, regular region of modeled space should be readily adaptable to modeling parallel dimensions.

The animator 414 may produce raw model data that is not configured for efficient distribution to remote clients. Accordingly, the animator may cooperate with an output control module 420 to prepare the output data 404 for distribution to remote clients. This may include translation or transformation of the animated model data from the animator to a format that is suitable for distribution to system clients. The form of translation or transformation will depend on the application software used at the client level and other details that should be apparent to one of ordinary skill.

According to the foregoing, therefore, a group server may execute a method 500 for operating a virtual interactive classroom using groups, as shown in FIG. 5. A classroom server may initiate and operate a multi-user process in response to input from multiple remote clients 502 via a wide area network. The server may aggregate user inputs from the clients, process the inputs to provide a process output, and transmit the process output to the clients. Optionally, the server may process the input such that each client receives different but related output. The process output may be configured to generate a simulation of a multi-user environment on each of the client computers. The process may simulate an event such as a classroom session or performance event.

The server may monitor user ID's for each respective client 503. Inputs may be processed by the server according to a role or authority designated for each user ID. For example, a professor role may be assigned to input from a client operated by a user identified as the specified professor or performer for a specified class or performance event. A moderator or assistant role may be assigned to input from a client identified as a teaching assistant or show manager. A student or spectator role may be assigned to inputs from other participating clients. The server may handle each input differently depending on the assigned role or authority level.

At 504, the classroom server may divide input from the plurality of clients into segregated groups, such that input from groups of clients are processed together to provide segregated process outputs specific to each respective group 506. Each client is a particular group may thereby receive process output for modeling a classroom or performance environment for the group in which it is member, and not for other groups.

A client authorized via a user identifier as a performer or moderator may provide digital input to the server for processing and transmission to all participating clients regardless of group identity. The server may therefore receive input from a professor/performer client and process the input as a common process output. The classroom server may provide the common process outputs to all of the groups 508. For example, the classroom server may provide an animated output generated from input received from a professor client to all groups. All groups therefore may receive and view the animation of the professor speaking, such as via audio or text output.

The server may additionally provide an audio or text chat service 510 within each group. The server may therefore operate separate chat services, one for each group. Each member of the group may thereby chat with members of the same group, while simultaneously receiving the process output for providing the classroom or performance environment.

A client authorized via a user identifier as an assistant or moderator may provide digital input to the server for controlling output of the common process output to the clients in the particular group to which the assistant or moderator is assigned. The server may receive multiple such inputs for different groups. The server may control the common output or group-specific process outputs in response to input from the assigned assistant or moderator 512. For example, the server may pause the common audio or video stream and/or animation output to the group assigned to a particular moderator client, in response to a “pause” command from a moderator client. Immediately after the pause command is executed, the server may substitute process output generated from input received from the moderator client for the common output to the moderator's assigned client group. In the meanwhile, the server may store the common output stream in a buffer or cache for later play. Then, in response to a “play” or “unpause” command from the moderator client, the server may resume play of the common output to the temporarily paused group, for example, “Group ‘A’, from the memory cache, while stopping output generated from the moderator client.

Immediately after resuming play of the common output to Group ‘A’, the server may speed up play of the common output 514 to the formerly paused group, to permit re-synchronization of Group ‘A’ to the live process output. For example, the server may increase the frame rate of an animation and/or delete or “fast forward” through silent portions of the process output, until the cache is emptied. In the alternative, or in addition, the server may continue to cache the common output and play delayed output to the formerly paused Group A 516, either until there is an intermission or break in the common output, or until termination of the on-line classroom or performance session.

Classroom or performance sessions may last for a predetermined period of time, for indefinitely until signaled by the client providing the professorial or performance input. Accordingly, the server maintains the session open until, in response to a clock input, or input from the professor/performer client, terminating the session 518. After session termination, the server may direct or permit navigation by connected clients to other areas of the system environment via a menu system or by moving an avatar through a modeled space.

Method 500, or portions thereof, may be coded as machine readable instructions for performance by one or more programmable computers, and recorded on a computer-readable medium. The depicted method merely exemplifies an implementation for operating a virtual interactive classroom using groups. The present technology is not limited by these examples. The appended claims defined the claimed subject matter.

1. A method comprising:
receiving, at a server, input from multiple clients to model a virtual reality classroom in which input from at least one designated instructor client and input from designated student ones of the multiple clients are processed to control animated video and audio output of a multi-user modeled three-dimensional virtual reality classroom;
modeling, at the server, a common environment portion of the virtual reality classroom responsive to input from the instructor client;
modeling, at the server, at least two separate and distinct student group portions of the virtual reality classroom each responsive to input from different subsets of the student ones of the multiple clients;
transmitting a first data stream from the server to a first one of the different subsets, configured for modeling the common environment portion and a first one of the at least two separate student group portions of the virtual reality classroom; while
substantially simultaneously transmitting a second data stream from the server to a second one of the different subsets, configured for modeling the common environment portion and a second one of the at least two separate student group portions of the virtual reality classroom.

2. The method of claim 1, further comprising transmitting a third data stream to the at least one designated instructor client, configured for modeling each of the at least two separate and distinct student group portions of the virtual reality classroom.

3. The method of claim 1, further comprising receiving input from designated moderator clients distinct from the instructor and student clients, for each of the at least two separate and distinct student group portions of the virtual reality classroom.

4. The method of claim 3, further comprising processing input from the designated moderator clients to enable moderator control of the common environment portions of the first and second data streams.

5. The method of claim 4, wherein the moderator control includes enabling pausing of video and audio output in the common environment portions at each of the student ones of the multiple clients.

6. The method of claim 5, wherein the moderator control further includes enabling resuming play of video and audio output at each of the student ones of the multiple clients, after the video and audio output is paused.

7. The method of claim 5, wherein the server resynchronizes play of the common environment portions of the first and second data streams after one of the common environment portions is paused, by altering relative rates of play of the common environment portions until the portions are substantially synchronous with each other.

8. The method of claim 1, further comprising serving first chat data enabling chat between members of the first one of the different subsets, and second chat data enabling chat between members of the second one of the different subsets.

9. The method of claim 8, wherein the first and second chat data comprises audio chat data.

10. The method of claim 8, wherein the first and second chat data comprises text chat data.

11. The method of claim 8, further comprising enabling chat between the instructor client and the first one of the different subsets by the first chat data, and enabling chat between the instructor client and the second one of the different subsets by the second chat data.

12. The method of claim 8, further comprising enabling chat between a first one of the moderator clients and the first one of the different subsets by the first chat data, and enabling chat between a second one of the moderator clients and the second one of the different subsets by the second chat data.

13. The method of claim 12, further comprising enabling the chat with the moderator clients while pausing play of the common environment portion.

14. The method of claim 1, further comprising maintaining synchronization between the common environment portions of the first and second data streams.

15. The method of claim 1, further comprising spawning a new student group portion of the virtual reality classroom each responsive to input from a new subset of the student ones of the multiple clients, in response to an increase in number of the student ones of the multiple clients.

16. The method of claim 1, further comprising assigning the student ones of the multiple clients to each of the subsets in response to parameter data describing student characteristics.

17. A computer-readable medium encoded with instructions for causing a computer processor to:
model a virtual reality classroom in response to input from at least one designated instructor client and input from designated student clients to provide animated video and audio output for a multi-user modeled three-dimensional virtual reality classroom, wherein the virtual reality classroom comprises a common environment portion responsive to input from the instructor client and at least two separate and distinct student group portions responsive to input from different subsets of the student clients;
transmit a first data stream from the server to a first one of the different subsets, configured for modeling the common environment portion and a first one of the at least two separate student group portions of the virtual reality classroom; while
substantially simultaneously transmitting a second data stream from the server to a second one of the different subsets, configured for modeling the common environment portion and a second one of the at least two separate student group portions of the virtual reality classroom.

18. The computer-readable medium of claim 17, further comprising instructions for causing a computer processor to independently pause respective ones of the common environment portions in response to moderator input.

19. The computer-readable medium of claim 18, further comprising instructions for causing a computer processor to resynchronize play of the respective ones of the common environment portions in response to receiving input indicating termination of a pause event.

20. A virtual reality classroom system, comprising:
means for modelling a virtual reality classroom in response to input from at least one designated instructor client and input from designated student clients to provide animated video and audio output for a multi-user modeled three-dimensional virtual reality classroom, wherein modeling provides the virtual reality classroom comprising a common environment portion responsive to input from the instructor client and at least two separate and distinct student group portions responsive to input from different subsets of the student clients; and
means for providing a first data stream from the server to a first one of the different subsets, configured for modeling the common environment portion and a first one of the at least two separate student group portions of the virtual reality classroom while substantially simultaneously transmitting a second data stream from the server to a second one of the different subsets, configured for modeling the common environment portion and a second one of the at least two separate student group portions of the virtual reality classroom.
